(19) United States
(12) Patent Application Publication
(10) Pub. No.: US 2021/0365910 A1
(43) Pub. Date: Nov. 25, 2021

(54) Vehicle Route and Fare Payment System

(71) Applicant: Wells Fargo Bank, N.A., San Francisco, CA (US)

(72) Inventor: H. Brock Kolls, Alpharetta, GA (US)

(21) Appl. No.: 15/420,620

(22) Filed: Jan. 31, 2017

(51) Int. Cl. G06Q 20/14; G01C 21/34; G01C 21/36

(52) U.S. Cl. CPC G06Q 20/145; G06Q 2240/00; G01C 21/36; G01C 21/3492

(57) ABSTRACT

A method for implementing a trip using an autonomous vehicle includes obtaining a geolocation of the autonomous vehicle. A destination for the trip using the autonomous vehicle is received by the autonomous vehicle. Two or more possible routes for the trip are determined by the autonomous vehicle. A fare is determined by the autonomous vehicle for each of the two or more possible routes. Information regarding the two or more possible routes for the trip and for the fare for each of the two or more possible routes for the trip is presented by the autonomous vehicle. A selection of one of the two or more possible routes is received by the autonomous vehicle. The autonomous vehicle is permitted vehicle to initiate the trip using the selection of the one of the two or more possible routes.

### BACKGROUND

Traffic congestion can be problematic in cities throughout the United States and the world. Costs can incur due to time lost in commuting, air pollution from vehicles idling in traffic and driver stress. Solutions to traffic congestion can include building more roads, building express lanes that can permit a faster commute for drivers who pay for the use of the express lanes and encouraging more drivers to use public transportation.

An autonomous vehicle is a vehicle that can detect its surroundings and navigate with little or no human input. Techniques such as radar, a global positioning system (GPS) and computer vision can be used to navigate the autonomous vehicle. Autonomous vehicles may be more common in the future and may impact traffic management issues.

### SUMMARY

Embodiments of the disclosure are directed to a method for implementing a trip using an autonomous vehicle, the method comprising: obtaining, by the autonomous vehicle, a geolocation of the autonomous vehicle; receiving, by the autonomous vehicle, a destination for the trip using the autonomous vehicle; determining, by the autonomous vehicle, two or more possible routes for the trip using the autonomous vehicle; determining, by the autonomous vehicle, a fare for each of the two or more possible routes for the trip; presenting, by the autonomous vehicle, information regarding the two or more possible routes for the trip and for the fare for each of the two or more possible routes for the trip; receiving, by the autonomous vehicle, a selection of one of the two or more possible routes; and permitting the autonomous vehicle to initiate the trip using the selection of the one of the two or more possible routes.

In another aspect, a method for selecting a transportation fare for an autonomous vehicle comprises: using a mobile electronic computing device, obtaining a geolocation on the mobile electronic computing device, the mobile electronic computing device having a same geolocation as the autonomous vehicle; sending the geolocation of the mobile electronic computing device to a server computer; identifying a destination of a trip using the autonomous vehicle; sending the destination of the trip to the server computer; receiving at the mobile electronic computing device, two or more possible routes for the trip using the autonomous vehicle; receiving at the mobile electronic computing device information regarding a fare for each of the two or more possible routes; sending a selection of one of the two or more possible routes to the server computer; and initiating the trip to the destination using the one of the two or more possible routes selected.

In yet another aspect, an electronic computing device comprises: a processing unit; and system memory, the system memory including instructions which, when executed by the processing unit, cause the electronic computing device to: obtain a geolocation of an autonomous vehicle; receive a destination for a trip using the autonomous vehicle; determine a first route for the trip using the autonomous vehicle, the first route being a premium route for which the trip can be completed in an optimal time; determine a second route for the trip using the autonomous vehicle, the second route comprising a longer and less heavily trafficked route that the premium route; determine a first fare for using the first route for the trip, the first fare resulting requiring a payment from a user of the autonomous vehicle; determine a second fare for using the second route for the trip, the second fare resulting in a credit to a financial account of the user of the autonomous vehicle; cause information to be displayed regarding the first route and the second route for the trip and for the first fare and the second fare; receive a selection of either the first route or the second route; permit the autonomous vehicle to initiate the trip using the selection of the first route or the second route; monitor the autonomous vehicle during the trip; and at a completion of the trip: when the trip is completed along the first route, debit the financial account of the user; and when the trip is completed along the second route, credit the financial account of the user.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system that supports a vehicle route and fare payment system.

FIG. 2 shows example modules of the organization electronic computing device of FIG. 1.

FIG. 3 shows an example method for implementing a vehicle route and fare payment system.

FIG. 4 shows another example method for implementing a vehicle route and fare payment system.

FIG. 5 shows example physical components of the organization electronic computing device of FIG. 1.

### DETAILED DESCRIPTION

The present disclosure is directed to systems and methods for providing alternative traffic routes to individuals and that can automatically obtain a payment or a credit from an individual for the completion of a selected traffic route.

At least one of the alternative traffic routes can be a premium traffic route that can permit a vehicle of the individual to navigate the traffic route in an optimal time. At least one of the alternative traffic routes can be a route that is less travelled during peak hours. Using the systems and methods, the individual can be charged a premium fare for using the premium route and the individual can be charge a lower fare or given a credit for using a less-travelled alternative route.

The vehicle can be one driven by the individual or can be an autonomous vehicle. As used in this disclosure, an autonomous vehicle is a driverless vehicle that can guide itself with little or no human intervention. The individual can communicate with the autonomous vehicle via a mobile electronic computing device, such as a smartphone, or other computing device associated with the autonomous vehicle. For example, the computing device associated with the autonomous vehicle can include a touch screen on which the individual can interact with the autonomous vehicle.

In an example implementation, the smartphone can contain a software application that can permit the individual to enter a travel destination. The smartphone can also include GPS software that can determine a geolocation of the individual, and thereby of the vehicle. The travel destination and the geolocation of the vehicle can be transmitted to an electronic computing device of a business or government organization that provides a traffic incentive program. In some implementations, the electronic computing device can be located at a site of the business or government organization. In other implementations, the electronic computing device can be located within the vehicle. When located at the site of the business or government organization, the electronic computing device of the business or government organization can be a server computer. When located in the vehicle, other electronic computing devices, for example an embedded electronic computing device, can be used.

As discussed in more detail herein, the traffic incentive program can offer a monetary incentive to individuals who use less travelled routes during peak hours and can charge individuals premium fares for using premium travel routes during peak hours. The organization can be a business organization that can provide the travel incentive program, typically in conjunction with a government organization. Alternatively, the travel incentive program can be implemented by a government organization.

The electronic computing device can determine one or more travel routes from the location of the vehicle to the travel destination. The electronic computing device can also identify traffic conditions along the travel routes and can determine approximate travel times along the travel routes taking into consideration the traffic conditions. The electronic computing device can also assign fares to each travel route. A premium are can be assigned to a premium travel route, one in which the travel time is low compared with the other travel routes. A lower fare or a monetary credit can be assigned to an alternative travel route that is less heavily travelled during peak conditions but that may be longer or take a longer time to reach the travel destination.

The electronic computing device can send the travel routes and associated fares to the individual's smartphone. Alternatively, when the electronic computing device is located within the autonomous vehicle, the travel routes and associated fares can be displayed on a touch screen of the electronic computing device. The individual can then select a travel route and a fare. For an autonomous vehicle, when a particular travel route is selected, the electronic computing device can send the travel route to the autonomous vehicle (or display the travel route when the electronic computing device is within the autonomous vehicle) and initiate the trip by the autonomous vehicle. The electronic computing device can track the progress of a vehicle during the trip and adjust a total fare for the trip as a result of any changes in the route.

The systems and methods disclosed herein are directed to a computer technology that can control routes taken by autonomous and other vehicles to reduce traffic congestion in a geographical area. An electronic computing device can receive trip information from users of the vehicles, can determine optimal and alternative routes using the trip information and can identify traffic conditions along the routes, can provide monetary incentives for using less trafficked alternate routes and can charge premium fares for using the optimal routes. In addition, the systems and methods can automatically debit or credit financial accounts of users when routes are completed.

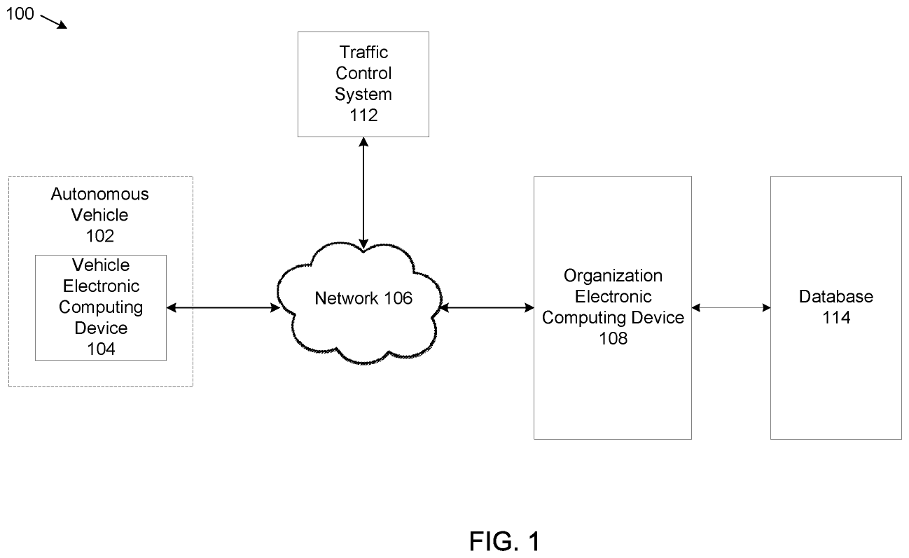

FIG. 1 shows an example vehicle route and fare payment system 100. The example system 100 can include an autonomous vehicle 102, a vehicle electronic computing device 104, a network 106, a business or government organization electronic computing device 108, a traffic control system 112 and a database 114.

The example autonomous vehicle 102 is a self-driving vehicle, for example a self-driving car. In an example implementation, the autonomous vehicle can be requested by a user via a smartphone of the user and used to transport the user to a specified destination. In other implementations, instead of an autonomous vehicle 102, a vehicle that the user can drive can be used.

The example vehicle electronic computing device 104 is an electronic computing device that is embedded in or otherwise contained within the autonomous vehicle. A software application in vehicle electronic computing device 104 can permit the user to enter a travel destination, to display alternate travel routes and fares, to select a travel route and to adjust a travel route if necessary.

The example network 106 is a computer network such as the Internet. Vehicle electronic computing device 104 can wirelessly connect to or otherwise access organization electronic computing device 108 and traffic control system 112 via network 106.

The example organization electronic computing device 108 is an electronic computing device of a business or a government organization. The organization electronic computing device 108 is typically a server computer, although other electronic computing devices can be used. In this disclosure, the organization electronic computing device 108 is assumed to be a server computer.

The organization electronic computing device 108 can include software functionality relating to vehicle route processing and fare determination that alternatively can be included in vehicle electronic computing device 104. As discussed in more detail later herein, this functionality can include determining travel routes for the user based on a starting location and a destination location, identifying traffic levels on the travel routes, determining fares for the travel routes, sending information regarding the travel routes and fares to the user, receiving a selection of a travel route from the user, initiating travel along the selected travel route, tracking the user's vehicle as it travels along the selected travel route and debiting or crediting a financial account or payment card of the user when the user's vehicle reaches the travel destination. Other or different functionality is possible. In different implementations of the system and methods, different parts of this functionality can be implemented on vehicle electronic computing device 104 and organization electronic computing device 108.

The example traffic control system 112 is a third-party system that can determine traffic levels and travel times for a geographical area. The organization electronic computing device 108 can send the traffic control system 112 alternative travel routes and the traffic control system 112 can provide traffic levels and travel times for the alternative travel routes based on current conditions.

The example database 114 is an electronic database of the business or government organization associated with organization electronic computing device 108. Database 114 can contain information regarding travel routes and can also contain personal information regarding the user including financial account and payment card information for the user.

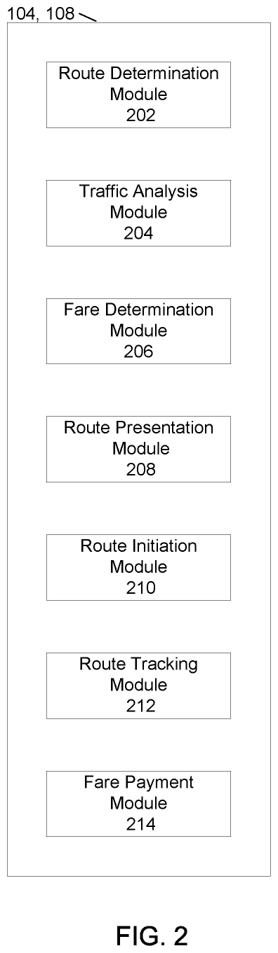

FIG. 2 shows example modules of the organization electronic computing device 108. The organization electronic computing device 108 includes a route determination module 202, a traffic analysis module 204, a fare determination module 206, a route presentation module 208, a route initiation module 210, a route tracking module 212 and a fare payment module 214. More, fewer or different modules are possible.

The example route determination module 202 receives a starting GPS location of the vehicle and a destination and determines one or more routes between the starting location and the destination. The route determination module 202 receives information regarding traffic conditions along the routes from the traffic analysis module 204 and identifies an optimal route, one in which a trip from the starting location to the destination can be made in an optimal amount of time. The route determination module 202 can also determine one or more alternate routes that may take a longer amount of time to complete but are less congested than the optimal route.

The example traffic analysis module 204 sends route information to the traffic control system 112 and the traffic control system 112 sends the traffic analysis module 204 information regarding traffic conditions on the routes. The traffic analysis module 204 then sends the information regarding the traffic conditions on the routes to the route determination module 202.

The example fare determination module 206 assigns a fare to each route. Typically, the optimal route is designated a premium route and has a highest fare of any of the routes. In addition, if there is an alternate route that can reduce traffic congestion by using a less trafficked route during peak hours, a credit can assigned when this alternate route is used. The business or government organization can use fares collected from premium routes to offset credits from alternate routes.

The example route presentation module 208 sends information regarding routes for display on a touch screen or other display device on vehicle electronic computing device 104 or the user's smartphone. The route presentation module 208 can format the information so that the information can easily be displayed to the user.

The example route initiation module 210 processes a route selection from the user and generates a route initiation signal. For an autonomous vehicle, the route initiation signal can cause the autonomous vehicle to start on the route. For a standard vehicle that requires a driver, the route initiation signal can indicate to the driver that the driver can start driving the vehicle towards the destination along the selected route.

The example route tracking module 212 receives GPS signals from the vehicle when the vehicle is travelling towards the route destination. The GPS signals allow the route tracking module 212 to track an actual route of the vehicle. If the vehicle deviates from the selected route, the route tracking module can provide updated route information to the fare determination module 206. The fare determination module 206 can then update the fare, if necessary.

The example fare payment module 214 processes payment information from the user when the vehicle reaches its destination. The amount of the payment is an amount confirmed by the user when the user selects the route. If there is a deviation from the route selected, the fare determination module 206 can update the fare. The fare payment module 214 can have access to a payment card of the user and either debit or credit the payment card for the payment amount at the when the route is completed.

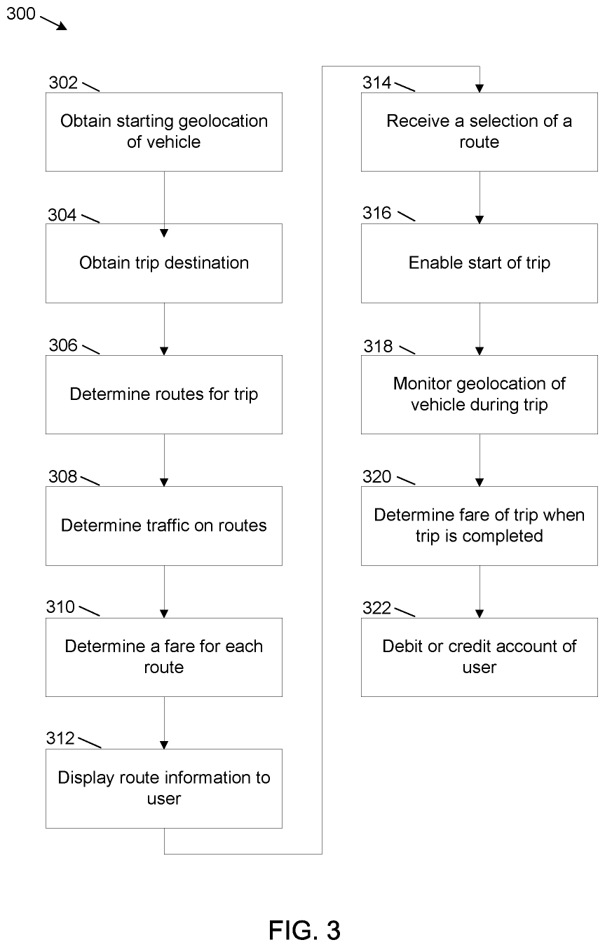

FIG. 3 shows a flowchart of an example method 300 for implementing a vehicle route and fare payment system at vehicle electronic computing device 104 and organization electronic computing device 108. For method 300, functionality included in modules 202-212 of FIG. 2 are implemented on vehicle electronic computing device 104 and functionality included in module 214 of FIG. 2 is implemented on organization electronic computing device 108. For other implementations, the functionality can be implemented differently.

At operation 302, vehicle electronic computing device 104 obtains a geolocation of the autonomous vehicle using GPS software on vehicle electronic computing device 104. For method 300, the autonomous vehicle is requested by a user, typically via a software application on the user's smartphone. When the autonomous vehicle arrives, the user can enter the autonomous vehicle and select a destination for a trip.

At operation 304, vehicle electronic computing device 104 receives the trip destination. The user can select the trip destination using a touch screen on vehicle electronic computing device 104 or using the user's smartphone.

At operation 306, based on the starting geolocation for the trip and the trip destination, vehicle electronic computing device 104 determines routes for the trip. When possible, multiple routes are determined. One of the multiple routes can be a premium route and at least one alternate route that is less trafficked route. The premium route generally comprises an optimal route for the trip, for example a most direct route and typically a fastest route. The alternate routes may be longer than the premium route, but less congested.

At operation 308, vehicle electronic computing device 104 determines traffic levels the routes for the trip. Typically, vehicle electronic computing device 104 sends information regarding the routes to a traffic control system, for example traffic control system 112. The traffic control system can monitor traffic on the routes and report traffic levels on the routes back to vehicle electronic computing device 104.

At operation 310, vehicle electronic computing device 104 determines a fare for each route. The fare can be determined based on how optimal the route is, including such factors as the time to complete the route and the amount of traffic on the route. Typically, a route that is highly congested, but that provides an optimal time, for example because the route is more direct than others or one that can use an express lane to expedite traffic, has a higher fare than a route that takes a longer amount of time to complete. Also, for alternate routes that are less trafficked, vehicle electronic computing device 104 can assign a lower price or even a credit to the route to encourage users to take an alternate route as a way to reduce traffic on more highly congested routes.

At operation 312, information regarding the routes is displayed on the touch screen of vehicle electronic computing device 104. The information can include the path of the routes and the fare that is assigned to each route. The information can also indicate whether any routes are considered to be a premium route and whether any routes have a credit associated with them.

At operation 314, vehicle electronic computing device 104 receives a selection of a route and associated fare from the user. The user can select the route via the touch screen on vehicle electronic computing device 104.

At operation 316, vehicle electronic computing device 104 initiates a start of the trip from the starting location to the destination. At operation 318, vehicle electronic computing device 104 tracks the route by monitoring the geolocation of the vehicle during the trip. The geolocation of the vehicle can be obtained by the GPS software on vehicle electronic computing device 104.

At operation 320, the fare of the trip is determined when the trip is completed. When the monitored route of the trip is the same as the selected route, the fare is determined to be the fare assigned to the route and previously accepted by the user. However, if the route is changed during the trip, an adjusted fare is calculated based on the route actually taken. The user can adjust the route of the trip by communicating a route change to the organization electronic computing device 108. For example, if there is an alternate route the user is interested in taking and the selected route is more congested than expected, for example because of an accident, the user may decide to request a change in the trip route.

At operation 322, organization electronic computing device 108 debits or credits a payment card of the user, based on the fare determined at operation 320.

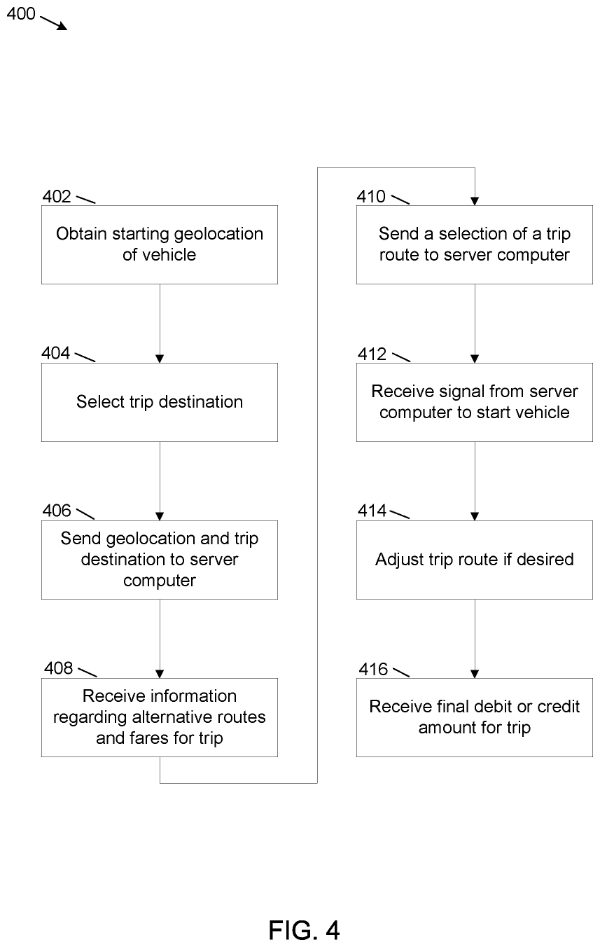

FIG. 4 shows a flowchart of an alternate example method 400 for implementing a vehicle route and fare payment system at vehicle electronic computing device 104 and organization electronic computing device 108. For method 400, the vehicle is an autonomous vehicle and the user having a smartphone is inside the autonomous vehicle. For method 400, the user's smartphone is used to select a destination and a route and route; fare processing is performed on organization electronic computing device 108.

Method 400 comprises an alternate implementation to that described for method 300. For the implementation described for method 300, route selection and fare processing are performed on vehicle electronic computing device 104 and user interaction is implemented via the touch screen on vehicle electronic computing device 104. For method 400, route selection and fare processing are performed on organization electronic computing device 108 and user interaction is implemented on the user's smartphone.

At operation 402, when the user is inside the vehicle, the geolocation of vehicle electronic computing device 104 is sent to organization electronic computing device 108. The geolocation can be obtained using GPS software on vehicle electronic computing device 104 or GPS software on the user's smartphone. The geolocation at operation 402 comprises a starting geolocation for the trip.

At operation 404, the user identifies a trip destination. The user can identify the trip destination using a software application on the user's smartphone. For method 400, the user can select a destination from a map displayed using the software application. In another implementation, the user can enter a specific destination into the software application.

At operation 406, the user's smartphone can send the starting geolocation and the trip destination to organization electronic computing device 108. For method 400, organization electronic computing device 108 is a server computer.

At operation 408, information from the server computer regarding alternative routes and fares for the trip is received at the user's smartphone.

At operation 410, the user makes a selection of a trip route and sends the selection of the trip route to the server computer.

At operation 412, the user's smartphone receives an indication from the server computer that the trip is about to start. For method 400, the autonomous vehicle receives a signal to initiate the trip. The signal can be initiated from organization electronic computing device 108 or from a third party computer system.

At operation 414, the user can decide to adjust the trip route. The user can request an adjustment to the trip route by using the software application. The user can request the adjustment to the trip route for one of a plurality of reasons, such as the route being slower than expected, the user deciding that a faster route is needed, an accident on the route, etc.

At operation 416, the user's smartphone receives information regarding a final debit or credit to the user's payment card based on the trip route actually taken.

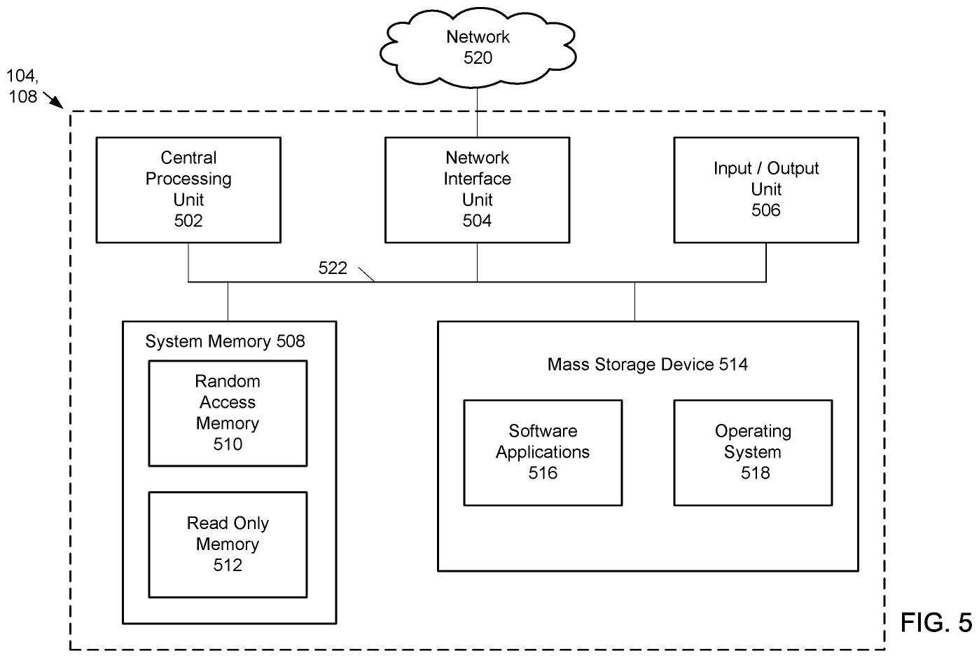

As illustrated in the example of FIG. 5, organization electronic computing device 108 includes at least one central processing unit (“CPU”) 502, also referred to as a processor, a system memory 508, and a system bus 522 that couples the system memory 508 to the CPU 502. The system memory 508 includes a random access memory (“RAM”) 510 and a read-only memory (“ROM”) 512. A basic input/output system that contains the basic routines that help to transfer information between elements within the organization electronic computing device 108, such as during startup, is stored in the ROM 512. The organization electronic computing device 108 further includes a mass storage device 514. The mass storage device 514 is able to store software instructions and data. Some or all of the components of the organization electronic computing device 108 can also be included in vehicle electronic computing device 104.

The mass storage device 514 is connected to the CPU 502 through a mass storage controller (not shown) connected to the system bus 522. The mass storage device 514 and its associated computer-readable data storage media provide non-volatile, non-transitory storage for the organization electronic computing device 108. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the organization electronic computing device 108.

According to various embodiments of the invention, the organization electronic computing device 108 may operate in a networked environment using logical connections to remote network devices through the network 520, such as a wireless network, the Internet, or another type of network. The organization electronic computing device 108 may connect to the network 520 through a network interface unit 504 connected to the system bus 522. It should be appreciated that the network interface unit 504 may also be utilized to connect to other types of networks and remote computing systems. The organization electronic computing device 108 also includes an input/output controller 506 for receiving and processing input from a number of other devices, including a touch user interface display screen, or another type of input device. Similarly, the input/output controller 506 may provide output to a touch user interface display screen or other type of output device.

As mentioned briefly above, the mass storage device 514 and the RAM 510 of the organization electronic computing device 108 can store software instructions and data. The software instructions include an operating system 518 suitable for controlling the operation of the organization electronic computing device 108. The mass storage device 514 and/or the RAM 510 also store software instructions and software applications 516, that when executed by the CPU 502, cause the organization electronic computing device 108 to provide the functionality of the organization electronic computing device 108 discussed in this document. For example, the mass storage device 514 and/or the RAM 510 can store software instructions that, when executed by the CPU 502, cause the organization electronic computing device 108 to display received data on the display screen of the organization electronic computing device 108.

Although various embodiments are described herein, those of ordinary skill in the art will understand that many modifications may be made thereto within the scope of the present disclosure. Accordingly, it is not intended that the scope of the disclosure in any way be limited by the examples provided.

1. A method for implementing a trip for a user using an autonomous vehicle, the method comprising:
obtaining, by the autonomous vehicle, a geolocation of the autonomous vehicle;
receiving, by the autonomous vehicle, a destination for the trip using the autonomous vehicle;
determining, by the autonomous vehicle, two or more possible routes for the trip for the user using the autonomous vehicle, with one of the two or more possible routes being a route that is longer in time but less traffic congested than other of the two or more possible routes;
determining, by the autonomous vehicle, a fare for each of the two or more possible routes for the trip, with each fare being a payment for the trip provided by the autonomous vehicle;
assigning, by the autonomous vehicle, the longer in time but less traffic congested route a lower fare in order to encourage the user to select the longer in time but less congested route in order to reduce traffic on more traffic congested routes;
presenting, by the autonomous vehicle, information regarding the two or more possible routes for the trip and for the fare for each of the two or more possible routes for the trip;
receiving, by the autonomous vehicle, a selection of one of the two or more possible routes;
permitting the autonomous vehicle to initiate the trip using the selection of the one of the two or more possible routes;
permitting the user to select an alternative route once the trip has started;
calculating an adjustment in the fare based on the alternative route; and
charging the user an adjusted fare when the trip is completed.

2. The method of claim 1, wherein one of the two or more possible routes comprises a premium route that can permit the trip to be completed in an optimal time.

3. The method of claim 2, further comprising associating a premium fare with the premium route, the premium fare being higher than the fare of any other of the two or more possible routes.

4. The method of claim 2, further comprising determining the premium route based on current traffic conditions for the two or more possible routes.

5. The method of claim 4, wherein a combination of the current traffic conditions and a distance of the premium route can provide a faster time for a completion of the trip than for any other of the two or more possible routes.

6. The method of claim 1, wherein one of the two or more possible routes comprises a route that is less heavily travelled than any other of the two or more possible routes.

7. The method of claim 6, further comprising assigning the fare to the route that is less heavily travelled that is less than the fare of any other of the two or more possible routes.

8. The method of claim 1, further comprising monitoring the geolocation of the autonomous vehicle between a starting geolocation and a destination geolocation.

9-11. (canceled)

12. The method of claim 1, wherein at least one of the two or more possible routes has an associated fare that can result in a credit to the user.

13-20. (canceled)
